(19) United States
(12) Patent Application Publication
(10) Pub. No.: US 2004/0216586 A1
(43) Pub. Date: Nov. 4, 2004

(54) Method of computing the pitch names of notes in MIDI-like music representations

(76) Inventor: David Meredith, Wisbech (GB)

Correspondence Address: DAVID MEREDITH, THE BARN, MIDDLE BROAD DROVE, TYDD STREET GILES, WISBECH, CAMBS, PE13 SPA, GB

(21) Appl. No.: 10/821,962

(22) Filed: Apr. 12, 2004

(30) Foreign Application Priority Data
Apr. 11, 2003 (GB) 0308456.3
Mar. 18, 2004 (GB) 0406166.9

(51) Int. Cl. H02M 5/00; G10H 7/00

(52) U.S. Cl. 84/645

(57) ABSTRACT

The invention described here consists of an algorithmic method called ps13 that reliably computes the correct pitch names (e.g., C♯4, B♭5 etc.) of the notes in a passage of tonal music, when given only the onset-time and MIDI note number of each note in the passage. The ps13 algorithm has been shown to be more reliable than previous algorithms, correctly predicting the pitch names of 99.33% of the notes in a test corpus containing 1729886 notes and consisting of 1655 movements from works by 9 baroque and classical composers. This was shown to be significantly greater than the percentage of notes in the same large corpus spelt correctly by the algorithms of Temperley, Cambouropoulos and Longuet-Higgins. ps13 is faster than the algorithms of Temperley and Cambouropoulos and requires less information in its input than Temperley's algorithm.

### BACKGROUND OF INVENTION

1. Field of the invention

This invention relates to the problem of constructing a reliable pitch spelling algorith that is, an algorithm that reliably computes the correct pitch names (e.g., C♯4, B♭5 etc.) of the notes in a passage of tonal music, when given only the onset-time, MIDI note number and possibly the duration of each note in the passage.

There are good practical reasons for attempting to develop a reliable pitch spelling algorithm. First, until such an algorithm is devised, it will be impossible to construct a reliable MIDI-to-notation transcription algorithm—that is, an algorithm that reliably computes a correctly notated score of a passage when given only a MIDI file of the passage as input. Commercial music notation programs (e.g., Sibelius (www.sibelius.com), Coda Finale (www.codamusic.com) and Nightingale (www.ngale.com)) typically use MIDI-to-notation transcription algorithms to allow the user to generate a notated score from a MIDI file encoding a performance of the passage to be notated. However, the MIDI-to-notation transcription algorithms that are currently used in commercial music notation programs are crude and unreliable. Also, existing audio transcription systems generate not notated scores but MIDI-like representations as output (see, for example, Davy, M. and Godsill, S. J. (2003). Bayesian harmonic models for musical signal analysis (with discussion). In J. M. Bernardo, J. O. Berger, A. P. Dawid, and A. F. M. Smith, editors, Bayesian Statistics, volume VII. Oxford University Press. Draft available online at http://www-sigproc.eng.cam.ac.uk/˜sjg/papers/02/harmonicfinal2.ps). So if one wishes to produce a notated score from a digital audio recording, one typically needs a MIDI-to-notation transcription algorithm (incorporating a pitch spelling algorithm) in addition to an audio transcription system.

Knowing the letter-names of the pitch events in a passage is also indispensible in music information retrieval and musical pattern discovery (see, e.g., Meredith, D., Lemstrom, K., and Wiggins, G. A. (2002). Algorithms for discovering repeated patterns in multidimensional representations of polyphonic music. Joural of New Music Research, 31(4), 321-345. Draft available online at http://www.titanmusic.com/papers/public/siajnmr_submit_{—}2.pdf). For example, the occurrence of a motive on a different degree of a scale (e.g., C-D-E-C restated as E-F-GE) might be perceptually significant even if the corresponding chromatic intervals in the patterns differ. Such matches can be found using fast, exact-matching algorithms if the pitch names of the notes are encoded, but exact-matching algorithms cannot be used to find such matches if the pitches are represented using just MIDI note numbers. If a reliable pitch spelling algorithm existed, it could be used to compute the pitch names of the notes in the tens of thousands of MIDI files of works that are freely available online, allowing these files to be searched more effectively by a music information retrieval (MIR) system.

In the vast majority of cases, the correct pitch name for a note in a passage of tonal music can be determined by considering the rôles that the note is perceived to play in the perceived harmonic structure and voice-leading structure of the passage. For example, when played in isolation in an equal-tempered tuning system, the first soprano note in FIG. 1a would sound the same as the first soprano note in FIG. 1b. However, in FIG. 1a, this note is spelt as a G♯4 because it is perceived to function as a leading note in A minor; whereas in FIG. 1b, the first soprano note is spelt as an A♭4 because it functions as a submediant in C minor. Similarly, the first alto note in FIG. 1b would sound the same as the first alto note in FIG. 1c in an equal-tempered tuning system. However, in FIG. 1b the first alto note is spelt as an F♯4 because it functions in this context as a subdominant in C minor; whereas, in FIG. 1c, the first alto note functions as a leading note in F♯ minor so it is spelt as an E♯4.

Nevertheless, it is not always easy to determine the correct pitch name of a note by considering the harmonic structure and voice-leading structure of its context. For example, as Piston observes, the tenor E♭4 in the third and fourth bars of FIG. 2 should be spelt as a D♯4 if one perceives the harmonic progression here to be ⁺II²-I as shown. But spelling the soprano E♭5 in the fourth bar as D♯5 would result in a strange melodic line (see p. 390 of Piston, W. (1978). Harmony. Victor Gollancz Ltd., London. Revised and expanded by Mark DeVoto.)

Such cases where it is difficult to determine the correct pitch name of a note in a tonal work are relatively rare—particularly in Western tonal music of the so-called ‘common practice’ period (roughly the 18th and 19th centuries). In the vast majority of cases, those who study and perform Western tonal music agree about how a note should be spelt in a given tonal context. Therefore a pitch spelling algorithm can be evaluated objectively by running it on tonal works and comparing the pitch names it predicts with those of the corresponding notes in authoritative published editions of scores of the works. However, this can only be done accurately and quickly if one has access to encodings of these authoritative scores in the form of computer files that can be compared automatically with the pitch spelling algorithm's output. Fortunately, a large collection of encodings of Western notation scores is available on the web at www.musedata.org.

2. Description of the Related Art

In order to obtain a clearer idea of the ‘state of the art’ in the field, three pitch spelling algorithms were run on two test corpora and their performance was compared. The algorithms compared were those of Cambouropoulos, Longuet-Higgins and Temperley (see Cambouropoulos, E. (2003). Pitch spelling: A computational model. Music Perception, 20(4), 411-430; Longuet-Higgins, H. C. (1987). The perception of melodies. In H. C. Longuet-Higgins, editor, Mental Processes: Studies in Cognitive Science, pages 105-129. British Psychological Society/MIT Press, London, England and Cambridge, Mass.; and Temperley, D. (2001). The Cognition of Basic Musical Structures. MIT Press, Cambridge, Mass.). In an initial pilot study, the test corpus used was the first book of J. S. Bach's Das Wohltemperirte Klavier (BWV 846-869), which contains 41544 notes. Then a larger-scale comparison was carried out using a corpus containing 1729886 notes and consisting of 1655 movements from works by 9 baroque and classical composers (Corelli, Vivaldi, Telemann, Bach, Handel, B. Marcello, Haydn, Mozart and Beethoven). Both corpora were derived from the MuseData collection of encoded scores (see Hewlett, W. B. (1997). MuseData: Multipurpose representation. In E. Selfridge-Field, editor, Beyond MIDI: The Handbook of Musical Codes, pages 402-447. MIT Press, Cambridge, Mass.).

Each encoding in these two test corpora consisted of an OPND representation (OPND stands for “onset, pitch-name, duration”). Each OPND representation is a set of triples, (t, n, d), each triple giving the onset time, t, the pitch name, n, and the duration, d, of a single note (or sequence of tied notes) in the score. The onset time and duration of each note are expressed as integer multiples of the largest common divisor of all the notated onset times and note durations in the score. For example, FIG. 3b gives the OPND representation of the score in FIG. 3a. Note that within each pitch name in an element in an OPND representation, each flat symbol is represented by an ‘F’ character and each sharp symbol is represented by an ‘S’ character (double-sharps are denoted by two ‘S’ characters, so, for example, F×4 is denoted by “FSS4”.)

Longuet-Higgins's Algorithm

Pitch spelling is one of the tasks performed by Longuet-Higgins's music.p program (see Longuet-Higgins, H. C. (1987). The perception of melodies. In H. C. Longuet-Higgins, editor, Mental Processes: Studies in Cognitive Science, pages 105-129. British Psychological Society/MIT Press, London, England and Cambridge, Mass.). The input to music. p must be in the form of a list of triples, <p,tₒₙ,t_{off}>, each triple giving the “keyboard position” p together with the onset time tₒₙ and the offset time t_{off} in centiseconds of each note. The keyboard position p is just the MIDI note number minus 48. So, for example, the keyboard position of middle C is 12. Longuet-Higgins intended the music.p program to be used only on monophonic melodies and explicitly warns against using it on “accompanied melodies” or what he calls “covertly polyphonic” melodies (i.e., compound melodies).

The algorithm computes a value of “sharpness” q for each note in the input. The sharpness of a note is a number indicating the position of the pitch name of the note on the line of fifths (see FIG. 4). Longuet-Higgins's algorithm tries to spell the notes so that the distance on the line of fifths between each note and the tonic at the point at which the note occurs is less than or equal to 6 (which corresponds to a tritone). The algorithm assumes at the beginning of the music that the first note is either the tonic or the dominant of the opening key and chooses between these two possibilities on the basis of the interval between the first two notes. The algorithm also assumes that two consecutive notes in the music are never separated by more than 12 steps on the line of fifths. In fact, if two consecutive notes in the music are separated by more than 6 steps on the line of fifths, then the algorithm treats this as evidence of a change of key.

Cambouropoulos's Algorithm

Cambouropoulos's method involves first converting the input representation into a sequence of pitch classes in which the pitch classes are in the order in which they occur in the music (the pitch classes of notes that occur simultaneously being ordered arbitrarily—see FIG. 5) (see Cambouropoulos, E. (2003). Pitch spelling: A computational model. Music Perception, 20(4), 411-430.) The pitch class of a note can be computed from its MIDI note number using the formula

PITCH CLASS=MIDI NOTE NUMBER mod 12.

Having derived an ordered set of pitch classes from the input, Cambouropoulos's algorithm then processes the music a window at a time, each window containing a fixed number of notes (between 9 and 15). Each window is positioned so that the first third of the window overlaps the last third of the previous window. Cambouropoulos allows ‘white note’ pitch classes (i.e., 0, 2, 4, 5, 7, 9 and 11) to be spelt in three different ways (e.g., pitch class 0 can be spelt as B♯, C♯ or D♭♭) and ‘black note’ pitch classes to be spelt in two different ways (e.g., pitch class 6 can be spelt as F♯ or G♭). Given these restricted sets of possible pitch names for each pitch class, the algorithm computes all possible spellings for each window. So, on average, if the window size is 9, there will be over 5000 possible spellings for each window. A penalty score is then computed for each of these possible window spellings. The penalty score for a given window spelling is found by computing a penalty value for the interval between every pair of notes in the window and summing these penalty values. A given interval in a particular window spelling is penalised more heavily if it is an interval that occurs less frequently in the major and minor scales. An interval is also penalised if either of the pitch names forming the interval is a double-sharp or a double-flat. For each window, the algorithm chooses the spelling that has the lowest penalty score.

Temperley's Algorithm

Temperley's pitch spelling algorithm is implemented in his harmony program which forms one component of his and Sleator's Melisma system (see Temperley, D. (2001). The Cognition of Basic Musical Structures. MIT Press, Cambridge, Mass.). The input to the harmony program must be in the form of a “note-list” giving the MIDI note number of each note together with its onset time and duration in milliseconds. Temperley's pitch spelling algorithm searches for the spelling that best satisfies three “preference rules”. The first of these rules stipulates that the algorithm should “prefer to label nearby events so that they are close together on the line of fifths”. This rule bears some resemblance to the basic principle underlying Longuet-Higgins's algorithm (see above). The second rule expresses the principle that if two tones are separated by a semitone and the first tone is distant from the key centre, then the interval between them should preferably be spelt as a diatonic semitone rather than a chromatic one. The third preference rule steers the algorithm towards spelling the notes so that what Temperley calls a “good harmonic representation” results.

Note, however, that Temperley's algorithm requires more information in its input than the other algorithms. In particular, it needs to know the duration of each note and the tempo at each point in the passage. It also needs to perform a full analysis of the metrical and harmonic structure of the passage in order to generate a high quality result. Also, it cannot deal with cases where two or more notes with the same pitch start at the same time.

Results of Running Algorithms on the First Book of J. S. Bach's Das Wohitemperirte Klavier

When the three algorithms described above were run on the first book of J. S. Bach's Das Wohltemperirte Klavier, the following results were obtained:

| Algorithm | % notes correct | Number of errors |
|---|---|---|
| Cambouropoulos | 93.74 | 2599 |
| Longuet-Higgins | 99.36 | 265 |
| Temperley | 99.71 | 122 |

Total number of notes in corpus = 41544.

As can be seen, on this corpus, Temperley's algorithm performed best, making only 122 errors and spelling 99.71% of the notes correctly.

### SUMMARY OF THE INVENTION

The invention described here consists of an algorithmic method called ps13 that reliably computes the correct pitch names (e.g., C♯4, B♭5 etc.) of the notes in a passage of tonal music, when given only the onset-time and MIDI note number of each note in the passage.

The ps13 algorithm has been shown to be more reliable than previous algorithms, correctly predicting the pitch names of 99.33% of the notes in a test corpus containing 1729886 notes and consisting of 1655 movements from works by 9 baroque and classical composers. This was shown to be significantly greater than the percentage of notes in the same large corpus spelt correctly by the algorithms of Temperley, Cambouropoulos and Longuet-Higgins. ps13 is faster than the algorithms of Temperley and Cambouropoulos and requires less information in its input than Temperley's algorithm.

The ps13 algorithm is best understood to be in two parts, Part I and Part II. Part I consists of the following steps:

1. computing for each pitch class 0≦p≦11 and each note n in the input, the pitch letter name S(p, n)∈{A, B, C, D, E, F, G} that n would have if p were the tonic at the point in the piece where n occurs (assuming that the notes are spelt as they are in the harmonic chromatic scale on p);

2. computing for each note n in the input and each pitch class 0≦p≦11, a value CNT(p, n) giving the number of times that p occurs within a context surrounding n that includes n, some specified number Kₚᵣₑ of notes immediately preceding n and some specified number Kₚₒₛₜ of notes immediately following n;

3. computing for each note n and each letter name l, the set of pitch classes C(n, l)={p|S(p, n)=l} (that is, the set of tonic pitch classes that would lead to n having the letter name l);

4. computing

$$N ( l , n ) = {\sum }_{p ∈ C ( n , l )} CNT ( p , n )$$

for each note n and each pitch letter name l;

5. computing for each note n, the letter name l for which N(l, n) is a maximum.

Part II of the algorithm corrects those instances in the output of Part I where a neighbour note or passing note is erroneously predicted to have the same letter name as either the note preceding it or the note following it. Part II of ps13

1. lowers the letter name of every lower neighbour note for which the letter name predicted by Part I is the same as that of the preceding note;

2. raises the letter name of every upper neighbour note for which the letter name predicted by Part I is the same as that of the preceding note;

3. lowers the letter name of every descending passing note for which the letter name predicted by Part I is the same as that of the preceding note;

4. raises the letter name of every descending passing note for which the letter name predicted by Part I is the same as that of the following note;

5. lowers the letter name of every ascending passing note for which the letter name predicted by Part I is the same as that of the following note;

6. raises the letter name of every ascending passing note for which the letter name predicted by Part I is the same as that of the preceding note.

### BRIEF DESCRIPTION OF DRAWINGS

FIG. 1 Examples of notes with identical MIDI note numbers being spelt differently in different tonal contexts (from p. 8 of Piston, W. (1978). Harmony. Victor Gollancz Ltd., London. Revised and expanded by Mark DeVoto).

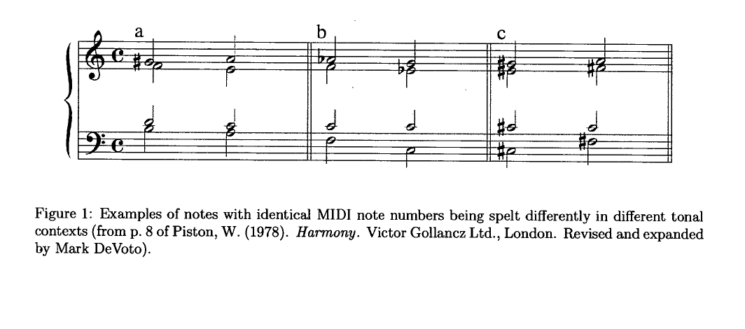

FIG. 2 Should the E♭s be spelt as D♯s? (FRom p. 390 of Piston, W. (1978). Harmony. Victor Gollancz Ltd., London. Revised and expanded by Mark DeVoto).

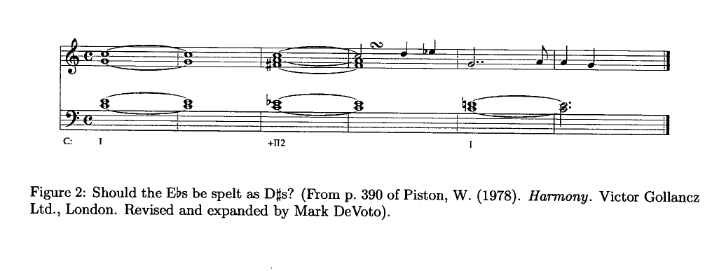

FIG. 3(a) Bars 1 to 4 of Bach's Fugue in D minor from Book 1 of Das Wohltemperirte Klavier (BWV 851). (b) The OPND representation of the score in (a).

FIG. 4 The line of fifths

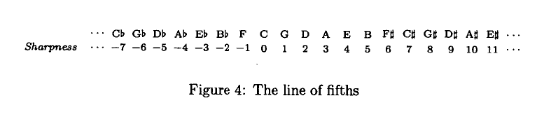

FIG. 5 The first step in Cambouropoulos's method involves converting the input representation into a sequence of pitch classes. The music is processed a window at a time. Each window contains 9 notes and the first third of each window overlaps the last third of the previous window

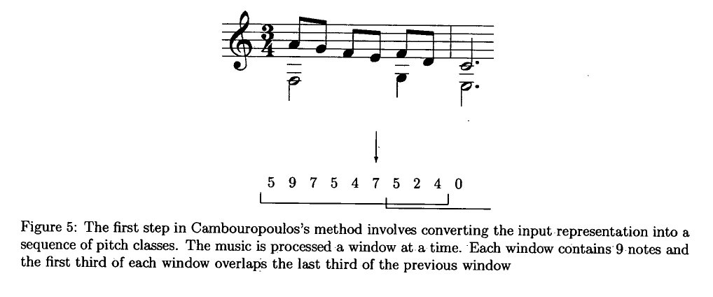

FIG. 6 Algorithm for computing the spelling table S.

FIG. 7 Algorithm for computing the relative morph list R.

FIG. 8 Algorithm for computing the chord list H.

FIG. 9 Neighbour note and passing note errors corrected by ps13.

FIG. 10 Algorithm for correcting neighbour note errors.

FIG. 11 Algorithm for correcting descending passing note errors.

FIG. 12 Algorithm for correcting ascending passing note errors.

FIG. 13 Algorithm for computing M′.

FIG. 14 Algorithm for computing P.

FIG. 15 PPN algorithm.

### DETAILED DESCRIPTION OF THE INVENTION

The invention consists of an algorithm, called ps13, that takes as input a representation of a musical passage (or work or set of works) in the form of a set I of ordered pairs <t,p_{c}>, each pair giving the onset time t and the chromatic pitch p_{c} of a single note or sequence of tied notes. The chromatic pitch of a note is an integer indicating the interval in semitones from A [symbol] 0 to the pitch of the note (i.e., p_{c}=MIDI NOTE NUMBER−21). The set I may be trivially derived from a MIDI file representation of the musical passage.

If eᵢ=<tᵢ, p_{c},i> and eⱼ=<tⱼ, p_{c},j> and eᵢ, eⱼ∈I then eᵢ is defined to be less than eⱼ, denoted by eᵢ<eⱼ, if and only if tᵢ<tⱼ or (tᵢ=tⱼΛp_{c,i}<p_{c,j}). Also, eᵢ≦eⱼ if and only if eᵢ<eⱼ or eᵢ=ⱼ.

The first step in ps13 is to sort the set I to give an ordered set

J=<<t₁,p_{c,1}>, <t₂,p_{c,2}>, . . . <t_{|I|},p_{c,|I|}>> (1)

containing all and only the elements of I, sorted into increasing order so that j>i→<tᵢ,p_{c,i}>≦<tⱼ, p_{c,j}> for all <tᵢ,p_{c,i}>, <tⱼ,p_{c,j}>∈J.

The second step in ps13 is to compute the ordered set

C=<c₁,c₂, . . . cₖ, . . . c_{|J|>} (2)

where cₖ=p_{c,k} mod 12, p_{c,k} being the chromatic pitch of the kth element of J. cₖ is the chroma of p_{c,k}.

If A is an ordered set of elements,

A=<a₁,a₂, . . . aₖ, . . . a_{|A|>}

then let A[j] denote the (j+1)th element of A (e.g., A[0]=a₁, A[1]=a₂). Also, let A[j,k] denote the ordered set that contains all the elements of A from A[j] to A[k−1], inclusive (e.g., A[1, 4]=<a₂,a₃,a₄>).

In addition to the set I, ps13 takes as input two numerical parameters, called the precontext, denoted by Kₚᵣₑ, and the postcontext, denoted by Kₚₒₛₜ. The precontext must be an integer greater than or equal to 0 and the postcontext must be an integer greater than 0. The third step in ps13 is to compute the ordered set

Φ=<φ(C[0]), φ(C[1]), . . . φ(C[k]), . . . φ(C[|C|−1])< (3)

where

φ(C[k])=<CNT(0,k), CNT(1,k), . . . CNT(11,k)> (4)

and CNT(c, k) returns the number of times that the chroma c occurs in the ordered set C[max({0, k−Kₚᵣₑ}), min({|C|,k+Kₚₒₛₜ})] (the functions max(B) and min(B) return the greatest and least values, respectively, in the set B).

Every pitch name has three parts: a letter name which must be a member of the set {A,B,C,D,E,F,G}; an inflection which must be a member of the infinite set {. . . ××,♯×,×,♯, [symbol] ,♭,♭♭,♭♭♭,♭♭♭♭, . . . }; and an octave number which must be an integer. By convention, if the inflection of a pitch name is equal to [symbol] it may be omitted, for example, C [symbol] 4 may be written C4. The octave number of ‘middle C’ is 4 and the octave number of any other C is one greater than the next C below it on the staff and one less than the next C above it on the staff. The octave number of any pitch name whose letter name is not C is the same as that of the nearest C below it on the staff. Thus B×3 sounds one semitone higher than C4 and C♭4 has the same sounding pitch as B [symbol] 3.

If N is a pitch name with letter name l(N) and octave number o(N), then the morph of N, denoted by m(N), is given by the following table

| l(N) | A | B | C | D | E | F | G |
|---|---|---|---|---|---|---|---|
| m(N) | 0 | 1 | 2 | 3 | 4 | 5 | 6 |

The morphetic octave of N, denoted by oₘ(N), is given by

$${o}_{m} ( N ) = \{ \begin{matrix}o ( N ) , & if m = 0 or m = 1 , \\ o ( N ) - 1 , & otherwise . \end{matrix} \qquad ( 5 )$$

The morphetic pitch of N, denoted by pₘ(N), is given by

pₘ(N)=m(N)+7oₘ(N). (6)

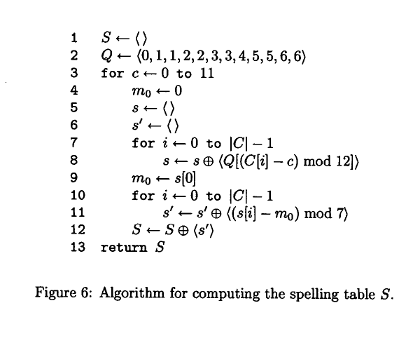

The fourth step in ps13 is to compute the spelling table, S. This is done using the algorithm expressed in pseudo-code in FIG. 6. In the pseudo-code used in this specification, block structure is indicated by indentation and the symbol “←” is used to denote assignment of a value to a variable (i.e., the expression “x←y” means “the value of variable x becomes equal to the value of y”). The symbol “Γ” is used to denote concatenation of ordered sets. Thus, if A and B are two ordered sets such that A=<a₁,a₂, . . . a_{|A|}> and B=<b₁,b₂, . . . b_{|B|}>, then

AΓB=<a₁,a₂, . . . a_{|A|},b₁,b₂, . . . b_{|B|}>.

Also, AΓ<>=<>ΓA=A.

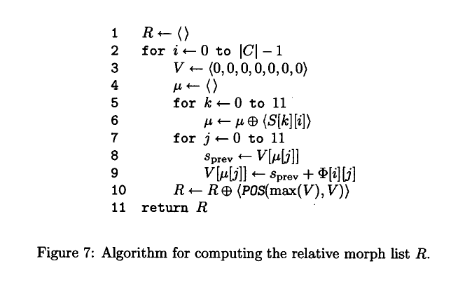

Having computed the spelling table S, the algorithm goes on to compute the relative morph list, R. This is computed using the algorithm in FIG. 7. If A is an ordered set of ordered sets, then A[i][j] denotes the (j+1)th element of the (i+1)th element of A. The expression S[k][i] in line 6 of FIG. 7 therefore denotes the (i+1)th element of the (k+1)th element of the spelling table S. If L is an ordered set and i is the value of at least one element of L, then the function POS(i, L) called in line 10 of FIG. 7 returns the least value of k for which L[k]=i.

The next step in ps13 is to compute the initial morph mᵢₙᵢₜ which is given by

mᵢₙᵢₜ=Qᵢₙᵢₜ[C[0]] (7)

where Qᵢₙᵢₜ=<0,1,1,2,2,3,4,4,5,5,6,6>.

Next, ps13 computes the morph list, M, which satisfies the following condition

(|M|=|C|)Λ(M[i]=(R[i]+mᵢₙᵢₜ) mod 7 for all 0≦i<|C|). (8)

Next, the ordered set O is computed which satisfies the following condition

(|O|=|C|)Λ(O[i]=<J[i][0],C[i],M[i]> for all 0≦i<|C|). (9)

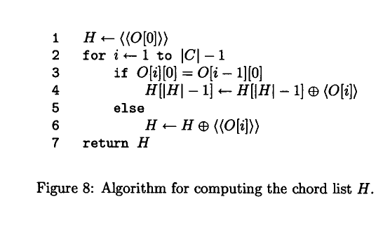

Next, an ordered set H called the chord list is computed using the algorithm in FIG. 8.

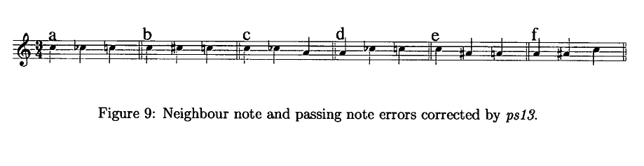

In the next three steps, the algorithm ensures that neighbour note and passing note figures are spelt correctly. FIG. 9 illustrates the six types of error corrected by the algorithm. FIG. 9a shows a lower neighbour note figure that is incorrectly spelt because the neighbour note (the middle note) has the same morphetic pitch as the two flanking notes. In this case, the morphetic pitch of the neighbour note is one greater than it should be. FIG. 9b shows a similar error in the case of an upper neighbour note figure. In this case, the morphetic pitch of the neighbour note is one less than it should be. The passing note figures in FIG. 9c and d are incorrect because the morphetic pitch of the passing note (the middle note) is one greater than it should be. Finally, the passing note figures in FIG. 9e and f are incorrect because the morphetic pitch of the passing note is one less than it should be.

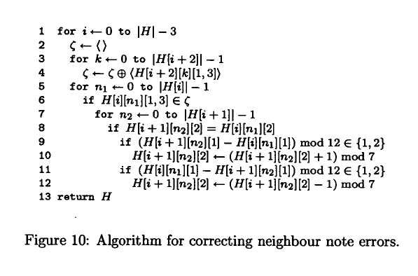

ps13 first corrects errors like the ones in FIG. 9a and b using the algorithm in FIG. 10. If A is an ordered set of ordered sets then the expression A[i][j, k] denotes the ordered set <A[i][j], A[i][j+1], . . . A[i][k−1]>. Thus, the expression H[i+2][k][1,3] in line 4 of FIG. 10 denotes the ordered set (H[i+2][k][1],H[i+2][k][2]). In FIG. 9a and b, the neighbour note is one semitone away from the flanking notes. The algorithm in FIG. 10 also corrects instances where the neighbour note is 2 semitones above or below the flanking notes but has the same morphetic pitch as the flanking notes.

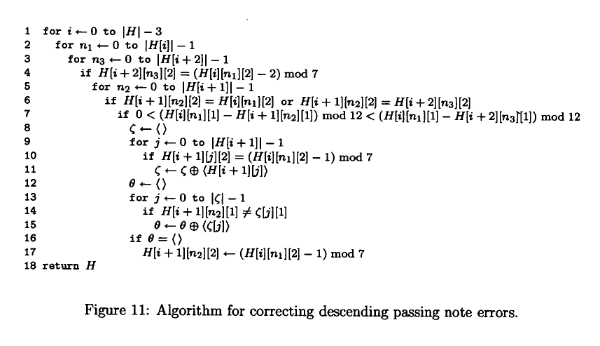

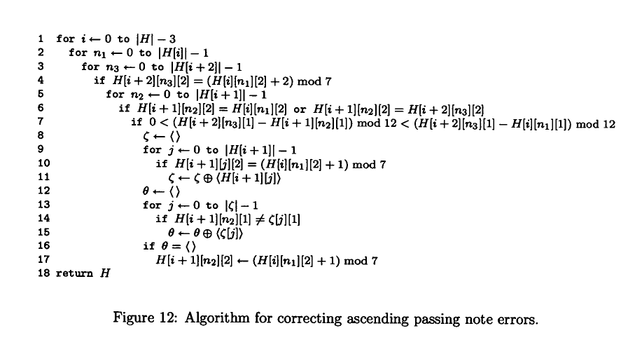

Next, ps13 corrects errors like the ones in FIG. 9c and e using the algorithm in FIG. 11. Then it corrects errors like the ones in FIG. 9d and f using the algorithm in FIG. 12. In FIG. 9c, d, e and f, the interval between the flanking notes is a minor third. The algorithms in FIGS. 11 and 12 also correct instances where the interval between the flanking notes is a major third.

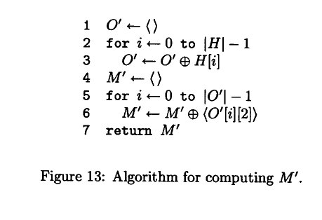

Having corrected neighbour note and passing note errors, ps13 then computes a new morph list M′ using the algorithm in FIG. 13.

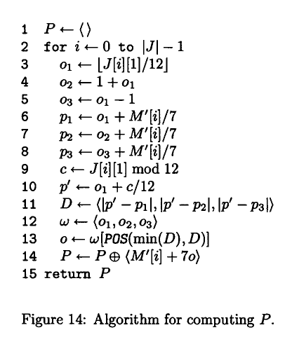

Having computed M′, it is now possible to compute a morphetic pitch for each note. This can be done using the algorithm in FIG. 14 which computes the ordered set of morphetic pitches, P.

Finally, from J and P, ps13 computes a representation Z which satisfies the following condition

(|Z|=|J|)Λ(Z[i]=(J[i][0],PPN(<J[i][1],P[i]>)> for all 0≦i<|Z|). (10)

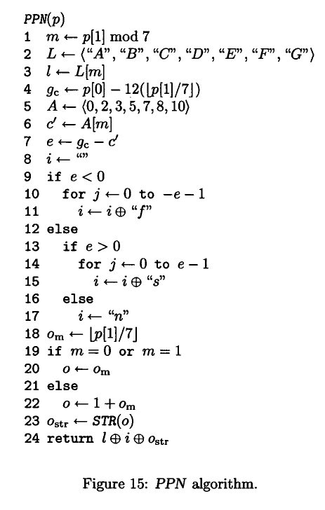

The function PPN(<p_{c},pₘ>) returns the unique pitch name whose chromatic pitch is p_{c} and whose morphetic pitch is pₘ. This function can be computed using the algorithm in FIG. 15. In this algorithm, anything in double inverted commas (“?”) is a string—that is, an ordered set of characters. If A and B are strings such that A=“abcdef” and B=“ghijkl”, then the concatenation of A onto B, denoted by AΓB, is “abcdefghijkl”. In the pitch names generated by PPN, the sharp signs are represented by ‘s’ characters and the flat signs are represented by ‘f’ characters. A double sharp is represented by the string “ss”. For example, the pitch name C×4 is represented in PPN by the string “Css4”. The empty string is denoted by “” and the function STR(n) called in line 23 returns a string representation of the number n. For example, STR(−5)=“−5”, STR(105.6)=“105.6”.

Results of Running ps13 on the First Book of J. S. Bach's Das Wohltemperirte Klavier

As explained above, ps13 takes as input a set I of ordered pairs, <t,p_{c}>, each one giving the onset time and chromatic pitch of each note. In addition, ps13 requires two numerical parameters, the precontext, Kₚᵣₑ, and the postcontext, Kₚₒₛₜ.

In order to explore the effect that varying the values of Kₚᵣₑ and Kₚₒₛₜ has on the performance of ps13, the algorithm was run 2500 times on the first book of J. S. Bach's Das Wohitemperirte Klavier, each time using a different pair of values <Kₚᵣₑ, Kₚₒₛₜ> chosen from the set

{<Kₚᵣₑ,Kₚₒₛₜ>|1≦Kₚᵣₑ≦50Λ1≦Kₚₒₛₜ≦50}.

For each pair of values <Kₚᵣₑ, Kₚₒₛₜ>, the number of errors made by ps13 on the test corpus was recorded.

It was found that ps13 made fewer than 122 mistakes (i.e., performed better than Temperley's algorithm) on this smaller test corpus for 2004 of the 2500 <Kₚᵣₑ, Kₚₒₛₜ> pairs tested (i.e., 80.160% of the <Kₚᵣₑ, Kₚₒₛₜ> pairs tested).

ps13 performed best on this test corpus when Kₚᵣₑ was set to 33 and Kₚₒₛₜ was set to either 23 or 25. With these parameter values, ps13 made only 81 errors on this test corpus—that is, it correctly predicted the pitch names of 99.81% of the notes in this test corpus.

The mean number of errors made by ps13 over all 2500 <Kₚᵣₑ,Kₚₒₛₜ> pairs was 109.082 (i.e., 99.74% of the notes were correctly spelt on average over all 2500 <Kₚᵣₑ, Kₚₒₛₜ> pairs). This average value was better than the result obtained by Temperley's algorithm for this test corpus. The standard deviation in the accuracy over all 2500 <Kₚᵣₑ, Kₚₒₛₜ> pairs was 0.08%.

Results of Running ps13 on the Larger Test Corpus

ps13 and the algorithms of Temperley, Cambouropoulos and Longuet-Higgins were then run on a much larger corpus containing 1729886 notes and consisting of 1655 movements from works by 9 baroque and classical composers (Corelli, Vivaldi, Telemann, Bach, Handel, B. Marcello, Haydn, Mozart and Beethoven). The values of Kₚᵣₑ and Kₚₒₛₜ for ps13 were set to 33 and 23, respectively, these being the values that produced the best results when the algorithm was run on the smaller corpus in the pilot study. The percentage of notes in the larger test corpus spelt correctly by each of the four algorithms was as follows:

| ps13 | Cambouropoulos | Temperley | Longuet-Higgins |
|---|---|---|---|
| 99.33% | 98.71% | 97.67% | 97.65% |

The results were analysed using McNemar's test and it was shown that ps13 spelt significantly more notes correctly than Cambouropoulos's algorithm (p<0.0001) which in turn spelt significantly more notes correctly than the algorithms of Temperley and Longuet-Higgins (p<0.0001). The difference between the scores achieved by Temperley and Longuet-Higgins was not significant (p=0.0954).

These results suggest that ps13 generally spells a greater proportion of the notes in tonal works correctly than previous pitch spelling algorithms.

Appendix: Lisp Implementation of ps13

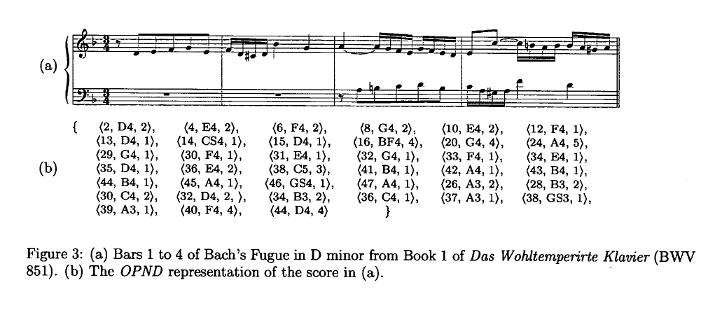

A Lisp implementation of ps13 is given below. In this implementation it is assumed that the input representation is a list of sublists, each sublist taking the form (t p_{c} d) where t, p_{c} and d are the onset time, chromatic pitch and duration, respectively, of a single note. For example, the passage in FIG. 3a would be represented by the list

[image]

Similarly, the output of the Lisp implementation of ps13 given below is represented as a list of sublists. For example, the output of this implementation of ps13 for the passage given in FIG. 3a is

[image]

Here is the Lisp code for an implementation of ps13:

```
(defun ps13 (&optional (input-filename (choose-file-dialog))
          (pre-context 33)
          (post-context 23))
  (let* ((sorted-input-representation
      (remove-duplicates
      (sort (with-open-file (input-file
              input-filename)
        (read input-file))
        #′vector-less-than)
      :test #′equalp))
    (onset-list (mapcar #′first sorted-input-representation))
    (chromatic-pitch-list
      (mapcar #′second sorted-input-representation))
    (chroma-list
      (mapcar #′chromatic-pitch-chroma chromatic-pitch-list))
    (n (list-length chroma-list))
    (chroma-vector-list
      (do* ((cvl nil)
        (i 0 (1+ i)))
        ((= i n)
        cvl)
      (setf cvl
        (append cvl
            (list
            (do* ((context
              (subseq chroma-list
              (max 0 (− i pre-context))
              (min n (+ i post-context))))
            (cv (list 0 0 0 0 0 0 0 0 0 0 0 0))
            (c 0 (+ 1 c)))
            ((= c 12)
            cv)
          (setf (elt cv c)
              (count c context))))))))
    (chromamorph-table (list 0 1 1 2 2 3 3 4 5 5 6 6))
    (spelling-table
    (do* ((first-morph nil nil)
        (spelling nil nil)
        (spelling2 nil nil)
        (st nil)
        (c 0 (1+ c)))
        ((= c 12)
        st)
      (setf spelling
          (mapcar #′(lambda (chroma-in-chroma-list)
          (elt chromamorph-table
            (mod (− chroma-in-chroma-list c) 12)))
        chroma-list))
      (setf first-morph (first spelling))
      (setf spelling2
          (mapcar #′(lambda (morph-in-spelling)
          (mod (− morph-in-spelling first-morph) 7))
        spelling))
      (setf st (append st (list spelling2)))))
      (relative-morph-list
      (do ((morph-vector (list 0 0 0 0 0 0 0)
                  (list 0 0 0 0 0 0 0))
        (rml nil)
        (i 0 (1+ i))
        (morphs-for-this-chroma nil
              nil)
        )
        ((= i n)
        rml)
        (setf morphs-for-this-chroma
          (mapcar #′(lambda (spelling)
                  (elt spelling i))
              spelling-table))
      (setf rml
          (do ((prev-score nil nil)
          (j 0 (1+ j)))
          ((= j 12)
          ;(pprint morph-vector)
          (append rml
            (list (position
              (apply #′max morph-vector)
              morph-vector))))
          (setf prev-score
          (elt morph-vector
              (elt morphs-for-this-chroma j)))
          (setf (elt morph-vector
              (elt morphs-for-this-chroma j))
          (+ prev-score
            (elt (elt chroma-vector-list i) j)))))))
    (initial-morph (elt ′(0 1 1 2 2 3 4 4 5 5 6 6)
            (mod (first chromatic-pitch-list) 12)))
    (morph-list (mapcar #′(lambda (relative-morph)
            (mod (+ relative-morph initial-morph) 7))
          relative-morph-list))
    (ocm (mapcar #′list onset-list chroma-list morph-list))
    (ocm-chord-list (do* ((cl (list (list (first ocm))))
            (i 1 (1+ i)))
          ((= i n)
            cl)
          (if (= (first (elt ocm i))
            (first (elt ocm (1− i))))
          (setf (first (last cl))
            (append (first (last cl))
              (list (elt ocm i))))
          (setf cl
            (append cl
              (list (list (elt ocm i))))))))
    (number-of-chords (list-length ocm-chord-list))
    ;neighbour notes
    (ocm-chord-list
    (do* ((i 0 (1+ i)))
      ((= i (− number-of-chords 2))
      ocm-chord-list)
      (dolist (note1 (elt ocm-chord-list i))
      (if (member (cdr note1)
          (mapcar #′cdr (elt ocm-chord-list (+ i 2)))
          :test #′equalp)
      (dolist (note2 (elt ocm-chord-list (1+ i)))
      (if (= (third note2)
          (third note1))
        (progn
        (if (member (mod (− (second note2) (second note1))
            12)
        ′(1 2))
          (setf (third note2)
          (mod (+ 1 (third note2)) 7)))
        (if (member (mod (− (second note1) (second note2))
            12)
        ′(1 2))
          (setf (third note2)
          (mod (− (third note2) 1) 7))))))))))
    ;downward passing notes
    (ocm-chord-list
    (do* ((i 0 (1+ i)))
      ((= i (− number-of-chords 2))
      ocm-chord-list)
    (dolist (note1 (elt ocm-chord-list i))
      (dolist (note3 (elt ocm-chord-list (+ i 2)))
      (if (= (third note3) (mod (− (third note1) 2) 7))
      (dolist (note2 (elt ocm-chord-list (1+ i)))
        (if (and (or (= (third note2)
          (third note1))
          (= (third note2)
          (third note3)))
        (< 0
          (mod (− (second note1) (second note2))
          12)
          (mod (− (second note1) (second note3))
          12)))
        (unless (remove-if
          #′null
          (mapcar
          #′(lambda (note)
          (/= (second note)
            (second note2)))
          (remove-if
          #′null
          (mapcar
          #′(lambda (note)
          (if (= (third note)
              (mod (− (third note1) 1)
                7))
          note))
          (elt ocm-chord-list (1+ i))))))
        (setf (third note2)
          (mod (− (third note1) 1) 7))))))))))
    ;upward passing notes
    (ocm-chord-list
    (do* ((i 0 (1+ i)))
      ((= i (− number-of-chords 2))
      ocm-chord-list)
    (dolist (note1 (elt ocm-chord-list i))
      (dolist (note3 (elt ocm-chord-list (+ i 2)))
      (if (= (third note3) (mod (+ (third note1) 2) 7))
      (dolist (note2 (elt ocm-chord-list (1+ i)))
        (if (and (or (= (third note2)
          (third note1))
          (= (third note2)
          (third note3)))
        (< 0
          (mod (− (second note3) (second note2))
          12)
          (mod (− (second note3) (second note1))
          12)))
        (unless (remove-if
          #′null
          (mapcar
          #′(lambda (note)
          (/= (second note)
            (second note2)))
          (remove-if
          #′null
          (mapcar #′(lambda (note)
              (if (= (third note)
              (mod (+ (third note1)
                1)
                7))
              note))
            (elt ocm-chord-list (1+ i))))))
        (setf (third note2)
          (mod (+ (third note1) 1) 7))))))))))
    (morph-list (mapcar #′third (apply #′append ocm-chord-list)))
    (morphetic-pitch-list
    (mapcar #′(lambda (chromatic-pitch morph)
      (let* ((morphetic-octave1 (floor chromatic-pitch 12))
          (morphetic-octave2 (+ 1 morphetic-octave1))
          (morphetic-octave3 (− morphetic-octave1 1))
          (mp1 (+ morphetic-octave1 (/ morph 7)))
          (mp2 (+ morphetic-octave2 (/ morph 7)))
          (mp3 (+ morphetic-octave3 (/ morph 7)))
          (chroma (mod chromatic-pitch 12))
          (cp (+ morphetic-octave1 (/ chroma 12)))
          (difference-list (list (abs (− cp mp1))
              (abs (− cp mp2))
              (abs (− cp mp3))))
          (morphetic-octave-list (list morphetic-octave1
                morphetic-octave2
                morphetic-octave3))
          (best-morphetic-octave
          (elt morphetic-octave-list
          (position (apply #′min difference-list)
            difference-list))))
      (+ (* 7 best-morphetic-octave) morph)))
      chromatic-pitch-list
      morph-list))
    (opd (mapcar #′(lambda (tpcd-triple morphetic-pitch)
        (list (first tpcd-triple)
          (list (second tpcd-triple)
          morphetic-pitch)
          (third tpcd-triple)))
        sorted-input-representation
        morphetic-pitch-list))
    (opnd (mapcar #′(lambda (opd-datapoint)
        (list (first opd-datapoint)
          (p-pn (second opd-datapoint))
          (third opd-datapoint)))
        opd)))
  opnd))
(defun chromatic-pitch-chroma (chromatic-pitch)
  (mod chromatic-pitch 12))
(defun vector-less-than (v1 v2)
  (cond ((null v2) nil)
    ((null v1) t)
    ((< (first v1) (first v2)) t)
    ((> (first v1) (first v2)) nil)
    (t (vector-less-than (cdr v1) (cdr v2)))))
(defun p-pn (p)
  (let* ((m (p-m p))
    (l (elt ′(“A” “B” “C” “D” “E” “F” “G”) m))
    (gc (p-gc p))
    (cdash (elt ′(0 2 3 5 7 8 10) m))
    (e (− gc cdash))
    (i “”)
    (i (cond ((< e 0)
      (dotimes (j (− e) i)
        (setf i (concatenate ′string i “f”))))
      ((> e 0)
      (dotimes (j e i)
        (setf i (concatenate ′string i “s”))))
      ((=e 0) “n”)))
    (om (p-om p))
    (oasa (if (or (= m 0) (= m 1))
      om
      (+ 1 om)))
    (o (format nil “˜D” oasa)))
  (concatenate ′string 1 i o)))
(defun p-om (p)
  (div (p-pm p) 7))
(defun p-pm (p)
  (second p))
(defun div (x y)
  (int (/ x y)))
(defun int (x)
  (values (floor x)))
(defun p-gc (p)
  (− (p-pc p)
  (* 12 (p-om p))))
(defun p-pc (p)
  (first p))
(defun p-m (p)
  (bmod (p-pm p) 7))
(defun bmod (x y)
  (− x
  (* y
    (int (/ x y)))))
```

I claim:

1. A method for computing the pitch names (i.e., C♯4, B♭3, etc.) of notes in a representation of music in which at least the onset time and MIDI note number (or chromatic pitch) of each note is given or can be trivially computed, comprising the steps of
(a) computing for each pitch class 0≦p≦11 and each note n in the input, the pitch letter name S(p, n)∈{A, B, C, D, E, F, G}, that n would have if p were the tonic at the point in the piece where n occurs (assuming that the notes are spelt as they are in the harmonic chromatic scale on p);
(b) computing for each note n in the input and each pitch class 0≦p≦11 a value CNT(p, n) giving the number of times that p occurs within a context surrounding n that includes n, some specified number Kₚᵣₑ of notes immediately preceding n and some specified number Kₚₒₛₜ of notes immediately following n;
(c) computing for each note n and each letter name l, the set of pitch classes C(n,l)={p|S(p,n)=l} (that is, the set of tonic pitch classes that would lead to n having the letter name l);
(d) computing
$$N ( l , n ) = {\sum }_{p ∈ C ( n , l )} CNT ( p , n )$$
for each note n and each pitch letter name l;
(e) computing for each note n, the letter name l for which N(l, n) is a maximum.

2. A method for computing the pitch names (i.e., C♯4, B♭3, etc.) of notes in a representation of music in which at least the onset time and MIDI note number (or chromatic pitch) of each note is given or can be trivially computed, comprising the steps of
(a) computing for each pitch class 0≦p≦11 and each note n in the input, the pitch letter name S(p, n)∈{A, B, C, D, E, F, G}, that n would have if p were the tonic at the point in the piece where n occurs (assuming that the notes are spelt as they are in the harmonic chromatic scale on p);
(b) computing for each note n in the input and each pitch class 0≦p≦11 a value CNT(p, n) giving the number of times that p occurs within a context surrounding n that includes n, some specified number Kₚᵣₑ of notes immediately preceding n and some specified number Kₚₒₛₜ of notes immediately following n;
(c) computing for each note n and each letter name l, the set of pitch classes C(n,l)={p|S(p, n)=l} (that is, the set of tonic pitch classes that would lead to n having the letter name l);
(d) computing
$$N ( l , n ) = {\sum }_{p ∈ C ( n , l )} CNT ( p , n )$$
for each note n and each pitch letter name l;
(e) computing for each note n, the letter name l for which N(l, n) is a maximum.
(f) correcting those errors in the output of the previous step in which a neighbour note or passing note is erroneously predicted to have the same letter name as either the note preceding it or the note following it, involving
i. lowering the letter name of every lower neighbour note for which the letter name predicted in step (e) is the same as that of the preceding note;
ii. raising the letter name of every upper neighbour note for which the letter name predicted in step (e) is the same as that of the preceding note;
iii. lowering the letter name of every descending passing note for which the letter name predicted in step (e) is the same as that of the preceding note;
iv. raising the letter name of every descending passing note for which the letter name predicted in step (e) is the same as that of the following note;
v. lowering the letter name of every ascending passing note for which the letter name predicted in step (e) is the same as that of the following note;
vi. raising the letter name of every ascending passing note for which the letter name predicted in step (e) is the same as that of the preceding note.

3. Computer software for computing the pitch names (i.e., C♯4, B♭3, etc.) of notes in a representation of music in which at least the onset time and MIDI note number (or chromatic pitch) of each note is given or can be trivially computed, comprising the steps of
(a) computing for each pitch class 0≦p≦11 and each note n in the input, the pitch letter name S(p, n)∈{A, B, C, D, E, F, G}, that n would have if p were the tonic at the point in the piece where n occurs (assuming that the notes are spelt as they are in the harmonic chromatic scale on p);
(b) computing for each note n in the input and each pitch class 0≦p≦11 a value CNT(P, n) giving the number of times that p occurs within a context surrounding n that includes n, some specified number Kₚᵣₑ of notes immediately preceding n and some specified number Kₚₒₛₜ of notes immediately following n;
(c) computing for each note n and each letter name l, the set of pitch classes C(n,l)={p|S(p, n)=l} (that is, the set of tonic pitch classes that would lead to n having the letter name l);
(d) computing
$$N ( l , n ) = {\sum }_{p ∈ C ( n , l )} CNT ( p , n )$$
for each note n and each pitch letter name l;
(e) computing for each note n, the letter name l for which N(l, n) is a maximum.

4. Computer software for computing the pitch names (i.e., C♯4, B♭3, etc.) of notes in a representation of music in which at least the onset time and MIDI note number (or chromatic pitch) of each note is given or can be trivially computed, comprising the steps of
(a) computing for each pitch class 0≦p≦11 and each note n in the input, the pitch letter name S(p, n) E{A, B, C, D, E, F, G}, that n would have if p were the tonic at the point in the piece where n occurs (assuming that the notes are spelt as they are in the harmonic chromatic scale on p);
(b) computing for each note n in the input and each pitch class 0≦p≦11 a value CNT(p, n) giving the number of times that p occurs within a context surrounding n that includes n, some specified number Kₚᵣₑ of notes immediately preceding n and some specified number Kₚₒₛₜ of notes immediately following n;
(c) computing for each note n and each letter name l, the set of pitch classes C(n,l)={p|S(p, n)=l} (that is, the set of tonic pitch classes that would lead to n having the letter name l);
(d) computing
$$N ( l , n ) = {\sum }_{p ∈ C ( n , l )} CNT ( p , n )$$
for each note n and each pitch letter name l;
(e) computing for each note n, the letter name l for which N(l, n) is a maximum.
(f) correcting those errors in the output of the previous step in which a neighbour note or passing note is erroneously predicted to have the same letter name as either the note preceding it or the note following it, involving
i. lowering the letter name of every lower neighbour note for which the letter name predicted in step (e) is the same as that of the preceding note;
ii. raising the letter name of every upper neighbour note for which the letter name predicted in step (e) is the same as that of the preceding note;
iii. lowering the letter name of every descending passing note for which the letter name predicted in step (e) is the same as that of the preceding note;
iv. raising the letter name of every descending passing note for which the letter name predicted in step (e) is the same as that of the following note;
v. lowering the letter name of every ascending passing note for which the letter name predicted in step (e) is the same as that of the following note;
vi. raising the letter name of every ascending passing note for which the letter name predicted in step (e) is the same as that of the preceding note.

5. Computer hardware for computing the pitch names (i.e., C♯4, B♭3, etc.) of notes in a representation of music in which at least the onset time and MIDI note number (or chromatic pitch) of each note is given or can be trivially computed, comprising the steps of
(a) computing for each pitch class 0≦p≦11 and each note n in the input, the pitch letter name S(p, n) ∈{A, B, C, D, E, F, G}, that n would have if p were the tonic at the point in the piece where n occurs (assuming that the notes are spelt as they are in the harmonic chromatic scale on p);
(b) computing for each note n in the input and each pitch class 0≦p≦11 a value CNT(P, n) giving the number of times that p occurs within a context surrounding n that includes n, some specified number Kₚᵣₑ of notes immediately preceding n and some specified number Kₚₒₛₜ of notes immediately following n;
(c) computing for each note n and each letter name l, the set of pitch classes C(n,l)={p|S(p, n)=l } (that is, the set of tonic pitch classes that would lead to n having the letter name l);
(d) computing
$$N ( l , n ) = {\sum }_{p ∈ C ( n , l )} CNT ( p , n )$$
for each note n and each pitch letter name l;
(e) computing for each note n, the letter name l for which N(l, n) is a maximum.

6. Computer hardware for computing the pitch names (i.e., C♯4, B♭3, etc.) of notes in a representation of music in which at least the onset time and MIDI note number (or chromatic pitch) of each note is given or can be trivially computed, comprising the steps of
(a) computing for each pitch class 0≦p≦11 and each note n in the input, the pitch letter name S(p, n)∈{A, B, C, D, E, F, G}, that n would have if p were the tonic at the point in the piece where n occurs (assuming that the notes are spelt as they are in the harmonic chromatic scale on p);
(b) computing for each note n in the input and each pitch class 0≦p≦11 a value CNT(P, n) giving the number of times that p occurs within a context surrounding n that includes n, some specified number Kₚᵣₑ of notes immediately preceding n and some specified number Kₚₒₛₜ of notes immediately following n;
(c) computing for each note n and each letter name l, the set of pitch classes C(n,l)={p|S(p, n)=l} (that is, the set of tonic pitch classes that would lead to n having the letter name l);
(d) computing
$$N ( l , n ) = {\sum }_{p ∈ C ( n , l )} CNT ( p , n )$$
for each note n and each pitch letter name l;
(e) computing for each note n, the letter name l for which N(l, n) is a maximum.
(f) correcting those errors in the output of the previous step in which a neighbour note or passing note is erroneously predicted to have the same letter name as either the note preceding it or the note following it, involving
i. lowering the letter name of every lower neighbour note for which the letter name predicted in step (e) is the same as that of the preceding note;
ii. raising the letter name of every upper neighbour note for which the letter name predicted in step (e) is the same as that of the preceding note;
iii. lowering the letter name of every descending passing note for which the letter name predicted in step (e) is the same as that of the preceding note;
iv. raising the letter name of every descending passing note for which the letter name predicted in step (e) is the same as that of the following note;
v. lowering the letter name of every ascending passing note for which the letter name predicted in step (e) is the same as that of the following note;
vi. raising the letter name of every ascending passing note for which the letter name predicted in step (e) is the same as that of the preceding note.
